(19) United States
(12) Patent Application Publication
(10) Pub. No.: US 2025/0023226 A1
(43) Pub. Date: Jan. 16, 2025

(54) ANTENNA DEVICE

(71) Applicant: MEDIATEK Inc., Hsinchu City (TW)

(72) Inventors: Chih-Hsiang LIU, Hsinchu City (TW); Shih-Huang YEH, Hsinchu City (TW)

(21) Appl. No.: 18/735,547

(22) Filed: Jun. 6, 2024

Related U.S. Application Data
(60) Provisional application No. 63/513,130, filed on Jul. 12, 2023.

(51) Int. Cl. H01Q 1/22; H01Q 1/48; H01Q 1/50

(52) U.S. Cl. CPC H01Q 1/2283; H01Q 1/48; H01Q 1/50

(57) ABSTRACT

An antenna device includes an antenna substrate and a semiconductor package. The antenna substrate includes a base and an input pad, wherein the base has a first surface, and the input pad is disposed on a first portion of the first surface. The semiconductor package is disposed on the first surface of the semiconductor package. The semiconductor package has a second surface facing the first surface, and an entirety of the second surface and a second portion of the first surface overlap.

This application claims the benefit of U.S. provisional application Ser. No. 63/513,130, filed Jul. 12, 2024, the subject matter of which is incorporated herein by reference.

The invention relates to a device, and more particularly to an antenna device.

### BACKGROUND OF THE INVENTION

Conventional antenna device includes an antenna layer and a plurality of related circuits. If the layout of the related circuits and the antenna layer is not proper, it may lead to more complex manufacturing processes and circuit design. Thus, how to properly design the layout of the related circuits and the antenna layer has become a prominent task for the industries.

### SUMMARY OF THE INVENTION

In one embodiment of the invention, an antenna device is provided. The antenna device includes an antenna substrate and a semiconductor package. The antenna substrate includes a base and an input pad, wherein the base has a first surface, and the input pad is disposed on a first portion of the first surface. The semiconductor package is disposed on the first surface of the semiconductor package. The semiconductor package has a second surface facing the first surface, and an entirety of the second surface and a second portion of the first surface overlap.

In another embodiment of the invention, an antenna device is provided. The antenna device includes a semiconductor package and an antenna substrate. The semiconductor package includes a base and an input pad, wherein the base has a first surface on which the input pad is disposed. The antenna substrate is disposed on the first surface of the semiconductor package and has a second surface facing the first surface. The semiconductor package has a projected region projected on the first surface of the base in a thickness direction of the antenna device, and the projected region entirely overlaps the first surface.

Numerous objects, features and advantages of the invention will be readily apparent upon a reading of the following detailed description of embodiments of the invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the invention will become more readily apparent to those ordinarily skilled in the art after reviewing the following detailed description and accompanying drawings, in which:

FIG. 1A illustrates a schematic diagram of a top view of an antenna device according to an embodiment of the invention;

FIG. 1B illustrates a cross-sectional view of the antenna device in FIG. 1A along a direction 1B-1B′;

FIG. 2 illustrates a schematic diagram of a cross-sectional view of the base of the antenna device in FIG. 1A;

FIG. 3 illustrates a schematic diagram of a cross-sectional view of a base according to another embodiment;

FIG. 4 illustrates a schematic diagram of a cross-sectional view of a base according to another embodiment;

FIG. 5 illustrates a schematic diagram of a cross-sectional view of a base according to another embodiment; and

FIG. 6 illustrates a schematic diagram of a cross-sectional view of a base according to another embodiment.

### DETAILED DESCRIPTION OF PREFERRED EMBODIMENTS

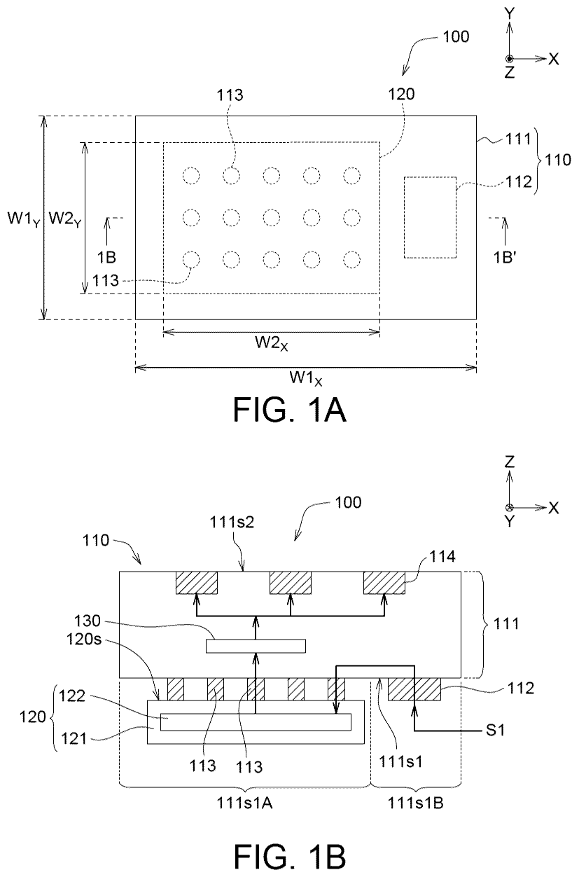

Referring to FIGS. 1A to 1B, FIG. 1A illustrates a schematic diagram of a top view of an antenna device 100 according to an embodiment of the invention, and FIG. 1B illustrates a cross-sectional view of the antenna device 100 in FIG. 1A along a direction 1B-1B′. The antenna device 100 is, for example, a PoP (Package-on-Package) antenna module.

As illustrated in FIGS. 1A and 1B, the antenna device 100 includes an antenna substrate 110, a semiconductor package 120 and a Radio frequency (RF) passive circuitry 130. The antenna substrate 110 includes a base 111 and an input pad 112, wherein the base 111 has a first surface 111s1, and the input pad 112 is disposed on a first portion 111s1A of the first surface 111s1. The semiconductor package 120 is disposed on the first surface 111s1 of the semiconductor package 110. In the present embodiment, the semiconductor package 120 has a second surface 120s facing the first surface 111s1, and the entirety of the second surface 120s and a second portion 111s1B of the first surface 111s1 overlap. The second portion 111s1B and the first portion 111s1A do not overlap in axis Z (for example, a thickness direction of the antenna device 100). Since the input pad 112 is disposed on the base 111, and does not occupy the space of the semiconductor package 120, the antenna device 100 has a thin thickness in comparison with the input pad 112 being disposed on the semiconductor package 120. Furthermore, at least 500 μm to 1000 μm of the module height reduction may be achieved due to the input pad 112 being disposed on the antenna substrate 110.

As illustrated in FIG. 1A, the semiconductor package 120 has a projected region projected on the first surface 111s1 of the base 111, the projected region has a second area, and the first surface 111s1 has a first area. The projected region entirely overlaps the first surface 111s1. The antenna substrate 110 has a first width W1_{Y} in axis Y, and the semiconductor package 120 has a second width W2_{Y} in axis Y, wherein the first width W1_{Y} and the second width W2_{Y} satisfy the following formula (1), wherein constant c1 may be greater than 1 (but not equal to 1). For example, constant c1 may range between 1.1 and 1.2, or even greater.

$$W {1}_{Y} = W {2}_{Y} \times c 1 \qquad ( 1 )$$

In addition, the antenna substrate 110 has a first length W1ₓ in axis X, and the semiconductor package 120 has a second width W2ₓ in axis X, wherein the first length W1ₓ and the second width W2ₓ satisfy the following formula (2), wherein constant c2 may be greater than 1 (but not equal to 1). For example, constant c2 may range between 1.1 and 1.4, or even greater.

$$W {1}_{X} = W {2}_{X} \times c 2 \qquad ( 2 )$$

As illustrated in FIG. 1B, the base 111 may be formed by, for example, PCB process, LCP (Liquid Crystal Polymer) process, LTCC (Low Temperature Co-fired Ceramics) process, etc.

As illustrated in FIG. 1B, the antenna substrate 110 further includes at least one contact 113 formed on the first surface 111s1 of the base 111. The contacts 113 may be disposed on the first portion 111s1A of the first surface 111s1. The antenna substrate 110 may be connected with the semiconductor package 120 through the contacts 113.

As illustrated in FIG. 1B, the antenna substrate 110 further includes an antenna layer 114. The antenna layer 114 is disposed on the base 111. For example, the antenna layer 114 is disposed adjacent to a third surface 111s2 of the base 111 opposite to the first surface 111s1 and may be exposed form the third surface 111s2. The antenna layer 114 is electrically connected with the RF passive circuitry 130.

As illustrated in FIG. 1B, the RF passive circuitry 130 is disposed within the base 111. The RF passive circuitry 130 is electrically connected with the antenna layer 114 for matching (impedance matching) the antenna layer 114. The RF passive circuitry 130 may modulate an input signal S1 for radiation of the input signal S1 by the antenna layer 114. In an embodiment, the RF passive circuitry 130 may include at least one of a transmission line, a driver, a filter, a diplexer and a Balun.

Due to the RF passive circuitry 130 and the base 111 being integrated into one module, it may increase design flexibility of the RF passive circuitry 130 and the base 111.

As illustrated in FIG. 1B, the semiconductor package 120 includes a semiconductor substrate 121 and an Integrated Circuit (IC) 122. Although not illustrated, the semiconductor package 120 further includes a molding compound formed on the semiconductor substrate 121 and encapsulating the IC 122. The semiconductor substrate 121 may be formed by, for example, PCB process, LCP (Liquid Crystal Polymer) process, LTCC (Low Temperature Co-fired Ceramics) process, etc. Alternatively, the semiconductor substrate 121 may be a portion of a silicon wafer, and the IC 122 may be a redistribution layer (RDL) formed on the semiconductor substrate 121. The IC 122 is disposed on the semiconductor substrate 121, and configured to up-convert the signal S1 to facilitate radiation by the antenna layer 114. In addition, the IC 122 is, for example, a RF front-end IC, a Power management IC or a combination thereof. In the present embodiment, the IC 122 and the RF passive circuitry 130 are disposed on two individual and separated components (that is, the semiconductor package 120 and the antenna substrate 110) respectively, and thus the manufacture processes and the circuit design of individual component may be simplified. At least 25% cost saving may be achieved due to easier semiconductor package molding and/or assembly.

As illustrated in FIG. 1B, the input signal S1 may be input to the base 111 through the input pad 112, and the input signal S1 may be transmitted to the antenna layer 114 through one of the contacts 113, the IC 122 of the semiconductor package 120, another one of the contacts 11 and the RF passive circuitry 130 in order.

Referring to FIG. 2, FIG. 2 illustrates a schematic diagram of a cross-sectional view of the base 111 of the antenna device 100 in FIG. 1A. The base 111 includes a plurality of dielectric layers 1111A and 1111B, a first layer structure L11 and a second layer structure 1113. The first layer structure L11 includes the input pad 112, the contacts 113, a plurality of first dielectric layers 1112A to 1112C and a grounding layer 1114A. The second layer structure L12 includes a plurality of second dielectric layers 1113A to 1113F, a grounding layer 1114B and a plurality of conductive layers 1115A to 1115D.

As illustrated in FIG. 2, the dielectric layer 1111A is connected with the dielectric layer 1111B. In the present embodiment, the grounding layer 1114A and the first dielectric layers 1112A to 1112C may be disposed on a side of the dielectric layers, and the grounding layer 1114B and the second dielectric layers 1113A to 1113F may be disposed on another side of the dielectric layers. For example, the grounding layer 1114A is formed on the dielectric layer 1111A, the grounding layer 1114B is formed on the dielectric layer 1111B, the first dielectric layers 1112A to 1112C are formed on the grounding layer 1114A, and the second dielectric layers 1113A to 1113F are formed on the grounding layer 1114B.

As illustrated in FIG. 2, in the present embodiment, the antenna layer 114 and the RF passive circuitry 130 may be separated by the grounding layers 1114A and 1114B. The RF passive circuitry 130 may be electromagnetically shielded by the grounding layers 1114A and 1114B.

As illustrated in FIG. 2, the number of the dielectric layers which are located above grounding layer 1114A is more than the number of the dielectric layers which are located below grounding layer 1114A. For example, the number of the dielectric layers 1111A and 1111B and the second dielectric layers 1113A to 1113F is eight, and the number of the first dielectric layers 1112A to 1112C is three.

As illustrated in FIG. 2, at least one of the conductive layers 1115A to 1115D may be antenna layer. The conductive layers 1115A to 1115D may be formed on the second dielectric layers 1113A to 1113F. For example, one of the conductive layers 1115A to 1115D may be formed on one of the second dielectric layers 1113A to 1113F. In the present embodiment, the conductive layer 1115A is formed on the second dielectric layer 1113C, and the conductive layer 1115B is formed on the second dielectric layer 1113D, the conductive layer 1115C is formed on the second dielectric layer 1113E, and the conductive layer 1115D is formed on the second dielectric layer 1113F.

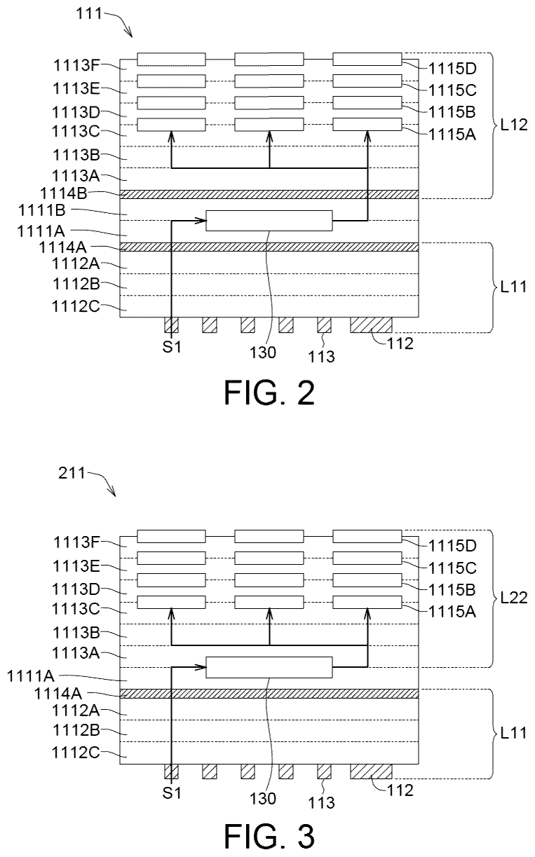

Referring to FIG. 3, FIG. 3 illustrates a schematic diagram of a cross-sectional view of a base 211 according to another embodiment. The base 211 includes the dielectric layer 1111A, the first layer structure L11 and a second layer structure L22. The second layer structure L22 includes a plurality of the second dielectric layers 1113A to 1113F, the grounding layer 1114B and a plurality of the conductive layers 1115A to 1115D.

As illustrated in FIG. 3, the base 211 may include the features the same as or similar to that of the base 111, and at least one difference is that the base 211 may omit at least one dielectric layer (for example, the dielectric layer 1111B) and/or at least one grounding layer (for example, the grounding layer 1114B). As a result, the number of the dielectric layers which are located above the grounding layer 1114A of the base 211 (as illustrated in FIG. 3) is less than the number of the dielectric layers which are located above the grounding layer 1114A of the base 111 (as illustrated in FIG. 2). For example, the number of the dielectric layer 1111A and the second dielectric layers 1113A to 1113F of the base 211 in FIG. 3 is seven, and the dielectric layers 1111A and 111B and the second dielectric layers 1113A to 1113F of the base 111 in FIG. 2 is eight.

As illustrated in FIG. 3, in the present embodiment, the antenna substrate 120 may include only one grounding layer, for example, the grounding layer 1114A, and the antenna layer 114 and the RF passive circuitry 130 may share the grounding layer 1114A.

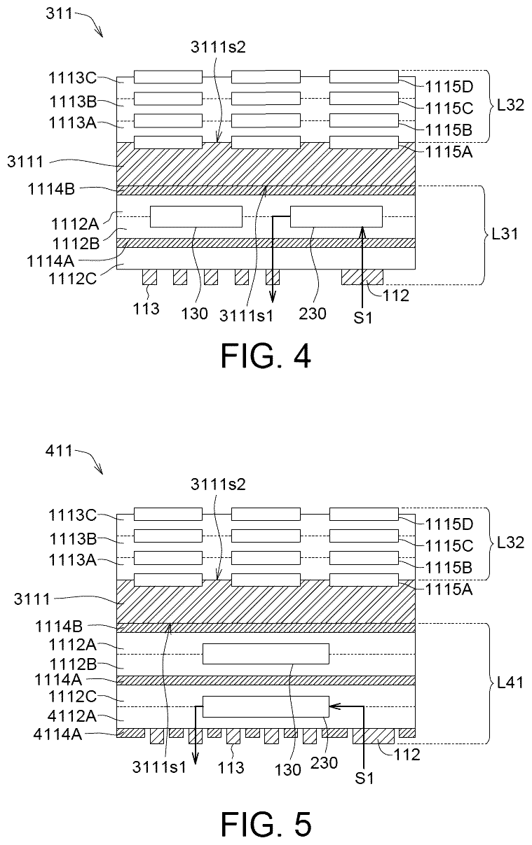

Referring to FIG. 4, FIG. 4 illustrates a schematic diagram of a cross-sectional view of a base 311 according to another embodiment. The base 311 includes a core 3111, a first layer structure L31 and a second layer structure L32. The core 3111 has a first core surface 3111s1 and a second core surface 3111s2 opposite to the first core surface 3111s1. The first layer structure L31 is disposed on the first core surface 3111s1 and includes a plurality of first layers. The second layer structure L32 is disposed on the second core surface 3111s2 and includes a plurality of second layers. The input pad 112 is disposed on the first layer structure L31.

As illustrated in FIG. 4, the core 3111 may be formed of a resin including FR4, BT, BF, etc.

As illustrated in FIG. 4, the first layers of the first layer structure L31 include, for example, a plurality of first conductive layer (for example, the grounding layers 1114A and 1114B, the contacts 113, the input pad 112, the RF passive circuitry 130 and a circuitry 230) and/or a plurality of dielectric layers (for example, the first dielectric layers 1112A to 1112C). In the present embodiment, the RF passive circuitry 130 and the circuitry 230 belong to the same level layer, and the contacts 113 and the input pad 112 belong to the same level layer, wherein the same level layer may be formed in the same manufacturing process. In an addition, the circuitry 230 includes PWR, MIPI, IF, etc.

As illustrated in FIG. 4, due to the RF passive circuitry 130 and the circuitry 230 being located at the same level layer, the RF passive circuitry 130 and the circuitry 230 both may be electromagnetically shielded by the grounding layers 1114A and 1114B.

As illustrated in FIG. 4, the second layers of the second layer structure L32 include, for example, a plurality of second conductive layer (for example, the conductive layers 1115A to 1115D) and/or a plurality of first dielectric layers (for example, the second dielectric layers 1113A to 1113C).

As illustrated in FIG. 4, the number of the first layers of the first layer structure L31 is equal to the number of the second layers of the second layer structure L32. For example, the number of first the conductive layers in the first layer structure L31 is four, and the number of the second conductive layers in the second layer structure L32 is four. For another example, the number of the first dielectric layers in the first layer structure L31 is three, and the number of the second dielectric layers in the second layer structure L32 is three.

Referring to FIG. 5, FIG. 5 illustrates a schematic diagram of a cross-sectional view of a base 411 according to another embodiment. The base 411 includes the core 3111, a first layer structure L41 and the second layer structure L32. The core 3111 has the first core surface 3111s1 and the second core surface 3111s2 opposite to the first core surface 3111s1. The first layer structure L41 is disposed on the first core surface 3111s1 and includes a plurality of first layers. The second layer structure L32 is disposed on the second core surface 3111s2 and includes a plurality of second layers. The input pad 112 is disposed on the first layer structure L41.

As illustrated in FIG. 5, the base 411 may include the features the same as or similar to that of the base 311, and at least one difference is that the base 411 further include a grounding layer 4114A and a first dielectric layer 4112A.

As illustrated in FIG. 5, the first layers of the first layer structure L41 include, for example, a plurality of first conductive layer (for example, the grounding layers 1114A and 1114B, the contacts 113, the input pad 112, the RF passive circuitry 130, the circuitry 230 and the grounding layer 4114A) and/or a plurality of dielectric layers (for example, the first dielectric layers 1112A to 1112C and the first dielectric layer 4112A). In the present embodiment, the RF passive circuitry 130 and the circuitry 230 are formed on two different level layers, and thus the different level layers may provide enough space for accommodating the traces and pads of the circuitries.

As illustrated in FIG. 5, the number of the first layers of the first layer structure L41 is more than the number of the second layers of the second layer structure L32. For example, the number of first the conductive layers in the first layer structure L41 is five, and the number of the second conductive layers in the second layer structure L32 is four. For another example, the number of the first dielectric layers in the first layer structure L31 is four, and the number of the second dielectric layers in the second layer structure L32 is three.

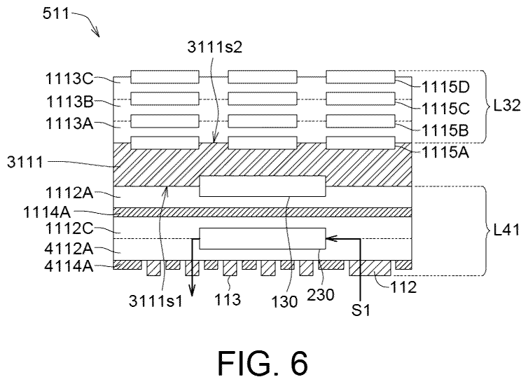

Referring to FIG. 6, FIG. 6 illustrates a schematic diagram of a cross-sectional view of a base 511 according to another embodiment. The base 511 includes the core 3111, a first layer structure L51 and the second layer structure L32. The core 3111 has the first core surface 3111s1 and the second core surface 3111s2 opposite to the first core surface 3111s1. The first layer structure L51 is disposed on the first core surface 3111s1 and includes a plurality of first layers. The second layer structure L32 is disposed on the second core surface 3111s2 and includes a plurality of second layers. The input pad 112 is disposed on the first layer structure L51.

As illustrated in FIG. 6, the base 511 may include the features the same as or similar to that of the base 411, and at least one difference is that at least one portion of the second layers of the second layer structure L32 and at least one portion of the first layers of the first layer structure L51 share one grounding layer. Furthermore, in comparison with the base 411 in FIG. 5, the base 511 may omit the grounding layer 1114B (which is disposed between the conductive layer 1115A and the RF passive circuitry 130) and the first dielectric layer 1112B, so that the conductive layers (1115A to 1115D) and the RF passive circuitry 130 may share the grounding layer 1114B.

As illustrated in FIG. 6, the first layers of the first layer structure L51 include, for example, a plurality of first conductive layer (for example, the grounding layer 1114A, the contacts 113, the input pad 112, the RF passive circuitry 130, the circuitry 230 and the grounding layer 4114A) and/or a plurality of dielectric layers (for example, the first dielectric layers 1112A, 1112C and the first dielectric layer 4112A). In the present embodiment, the RF passive circuitry 130 and the circuitry 230 are formed on two different level layers, and thus the different level layers may provide enough space for accommodating the traces and pads of the circuitries.

As illustrated in FIG. 6, the number of the first layers of the first layer structure L51 is equal to the number of the second layers of the second layer structure L32. For example, the number of first the conductive layers in the first layer structure L51 is five, and the number of the second conductive layers in the second layer structure L32 is four. For another example, the number of the first dielectric layers in the first layer structure L51 is three, and the number of the second dielectric layers in the second layer structure L32 is three.

Furthermore, as illustrated in FIG. 6, the first layer structure L51 and the second layer structure L32 include the same number of layers, so that the base 511 has a symmetric structure. As a result, the base 511 (or the antenna device including the base 511) may have less warpage and a higher assembly yield rate.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An antenna device, comprising:
an antenna substrate comprising a base and an input pad, wherein the base has a first surface, and the input pad is disposed on a first portion of the first surface; and
a semiconductor package disposed on the first surface of the base;
wherein the semiconductor package has a second surface facing the first surface, and an entirety of the second surface and a second portion of the first surface overlap.

2. The antenna device as claimed in claim 1, further comprising:
a Radio frequency (RF) passive circuitry disposed within the base.

3. The antenna device as claimed in claim 1, wherein the semiconductor package comprises:
a semiconductor substrate; and
an integrated circuit (IC) disposed on the semiconductor substrate.

4. The antenna device as claimed in claim 1, wherein the base comprises a grounding layer; the antenna substrate comprises:
a RF passive circuitry disposed within the base; and
an antenna layer disposed on the base;
wherein the antenna layer and the RF passive circuitry share the grounding layer.

5. The antenna device as claimed in claim 4, wherein the antenna substrate comprises only one grounding layer.

6. The antenna device as claimed in claim 1, wherein the base comprises:
a core having a first core surface and a second core surface opposite to the first core surface;
a first layer structure disposed within the first core surface and comprising a plurality of first layers; and
a second layer structure disposed within the second core surface and comprising a plurality of second layers;
wherein the input pad is disposed on the first layer structure, and the number of the first layers is more than the number of the second layers.

7. The antenna device as claimed in claim 1, wherein the base comprises:
a core having a first core surface and a second core surface opposite to the first core surface;
a first layer structure disposed within the first core surface and comprising a plurality of first layers; and
a second layer structure disposed within the second core surface and comprising a plurality of second layers;
wherein the input pad is disposed on the first layer structure, and the number of the first layers is equal to the number of the second layers.

8. The antenna device as claimed in claim 6, wherein the antenna substrate comprises:
two grounding layers; and
a RF passive circuitry disposed between the two grounding layers.

9. An antenna device, comprising:
a semiconductor package comprising a base and an input pad, wherein the base has a first surface on which the input pad is disposed;
and an antenna substrate disposed on the first surface of the semiconductor package and having a second surface facing the first surface;
wherein the semiconductor package has a projected region projected on the first surface of the base in a thickness direction of the antenna device, and the projected region entirely overlaps the first surface.

10. The antenna device as claimed in claim 9, further comprising:
a RF passive circuitry disposed within the base.

11. The antenna device as claimed in claim 9, wherein the semiconductor package comprises:
a semiconductor substrate; and
an integrated circuit disposed on the semiconductor substrate.

12. The antenna device as claimed in claim 9, wherein the base comprises a grounding layer; the antenna substrate comprises:
a RF passive circuitry disposed within the base; and
an antenna layer disposed on the base;
wherein the antenna layer and the RF passive circuitry share the grounding layer.

13. The antenna device as claimed in claim 12, wherein the antenna substrate comprises only one grounding layer.

14. The antenna device as claimed in claim 9, wherein the base comprises:
a core having a first core surface and a second core surface opposite to the first core surface;
a first layer structure disposed within the first core surface and comprising a plurality of first layers; and
a second layer structure disposed within the second core surface and comprising a plurality of second layers;
wherein the input pad is disposed on the first layer structure, and the number of the first layers is more than the number of the second layers.

15. The antenna device as claimed in claim 9, wherein the base comprises:
a core having a first core surface and a second core surface opposite to the first core surface;
a first layer structure disposed within the first core surface and comprising a plurality of first layers; and
a second layer structure disposed within the second core surface and comprising a plurality of second layers;
wherein the input pad is disposed on the first layer structure, and the number of the first layers is equal to the number of the second layers.

16. The antenna device as claimed in claim 14, wherein the antenna substrate comprises:
two grounding layers; and
a RF passive circuitry disposed between the two grounding layers.
